(19) United States
(12) Patent Application Publication
(10) Pub. No.: US 2014/0278619 A1
(43) Pub. Date: Sep. 18, 2014

(54) HARVEST SUPPORT METHOD AND HARVEST SUPPORT APPARATUS

(71) Applicant: FUJITSU LIMITED, Kawasaki-shi (JP)

(72) Inventor: Masafumi ASAI, Yokohama (JP)

(73) Assignee: FUJITSU LIMITED, Kawasaki-shi (JP)

(21) Appl. No.: 14/290,364

(22) Filed: May 29, 2014

Related U.S. Application Data
(63) Continuation of application No. PCT/JP2011/078969, filed on Dec. 14, 2011.

(51) Int. Cl. G06Q 50/02; G06Q 10/06

(52) U.S. Cl. CPC G06Q 50/02; G06Q 10/063
USPC 705/7.11

(57) ABSTRACT

A harvest support method executed by a computer includes determining a day within a harvest grace period of a first cultivation among cultivations of crops as a recommended harvest date of the first cultivation where the day has a minimum interval with a planned harvest date of the first cultivation; and determining a day included in a harvest grace period of a second cultivation among the cultivations of crops as a recommended harvest date of the second cultivation where the day has an interval with the planned harvest date of the first cultivation in which the interval is closest to an interval between the planned harvest date of the first cultivation and a planned harvest date of the second cultivation, wherein the harvest grace periods and planned harvest dates of the first and second cultivations are stored in a storage unit.

### CROSS-REFERENCE TO RELATED APPLICATIONS

This application is a continuation application of International Application PCT/JP2011/078969 filed on Dec. 14, 2011 and designated the U.S., the entire contents of which are incorporated herein by reference.

### FIELD

The disclosures herein generally relate to a harvest support method and a harvest support apparatus.

### BACKGROUND

Crops are planted following cultivation calendars that are customized for harvest times of the respective breeds of crops.

On the other hand, there are crops or crops for processing use that are difficult to preserve due to the high cost of preservation of the crops after harvest or the difficulty in quality preservation. For such crops and crops for processing use and the like, there are market needs for a stable supply throughout the year.

Thereupon, farmers carry out actual cultivations by making a schedule including multiple planting times that have respective target harvest times. For example, cultivations are carried out by shifting cultivation start timings multiple times to shift the harvest times.

### RELATED-ART DOCUMENTS

### Patent Documents

[Patent Document 1] Japanese Laid-open Patent Publication No. 2010-86242

However, the growth of crops is greatly influenced by weather conditions. Also, weather conditions are not necessarily stable year by year. Therefore, the intervals between harvest times may be shorter or longer than the initial schedule.

Consequently, this makes it difficult to secure enough personnel for harvest times, and/or produce skewed market conditions, which hinder a stable business of farming.

### SUMMARY

According to at least one embodiment of the present invention, a harvest support method executed by a computer includes determining a day within a harvest grace period of a first cultivation among cultivations of crops as a recommended harvest date of the first cultivation where the day has a minimum interval with a planned harvest date of the first cultivation; and determining a day included in a harvest grace period of a second cultivation among the cultivations of crops as a recommended harvest date of the second cultivation where the day has an interval with the planned harvest date of the first cultivation in which the interval is closest to an interval between the planned harvest date of the first cultivation and a planned harvest date of the second cultivation, wherein the harvest grace periods and planned harvest dates of the first and second cultivations are stored in a storage unit.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a schematic view illustrating an example of a cultivation schedule of cabbage J according to an embodiment of the present invention;

FIG. 2 is a schematic view illustrating an example of a relationship between planting dates and planned harvest dates of the cabbage J;

FIG. 3 is a schematic view illustrating an example of a first case where shifts occur on forecasted harvest dates and harvest intervals in a cultivation schedule;

FIG. 4 is a schematic view illustrating an example of a second case where shifts occur on forecasted harvest dates and harvest intervals in a cultivation schedule;

FIG. 5 is a schematic view illustrating an example of a determination method of recommended harvest dates for a case where forecasted harvest dates of cultivations are behind a cultivation schedule as a whole;

FIG. 6 is a schematic view illustrating an example of a determination method of recommended harvest dates for a case where forecasted harvest dates of cultivations are ahead of a cultivation schedule as a whole;

FIG. 7 is a schematic view illustrating an example of change of effective accumulated temperatures in a season where average temperatures are in a downward direction;

FIG. 8 is a schematic view illustrating an example of a hardware configuration of a harvest support apparatus according to an embodiment of the present invention;

FIG. 9 is a schematic view illustrating an example of a functional configuration of a harvest support apparatus according to an embodiment of the present invention; and

FIG. 10 is a flowchart illustrating an example of a determination process of recommended harvest dates.

### DESCRIPTION OF EMBODIMENTS

In the following, embodiments of the present invention will be described with reference to the drawings. In the present embodiment, cabbage of a breed J is adopted as a concrete example of crops. The cabbage of the breed J is referred to as the “cabbage J” below.

FIG. 1 is a schematic view illustrating an example of a cultivation schedule of the cabbage J according to the present embodiment. In a cultivation schedule A illustrated in FIG. 1, three cultivations of the cabbage J, or cultivations 1-3, have planting dates determined so that harvest dates come with intervals of about 15 days in early November to early December.

Specifically, cultivation 1 having the earliest planting date, has the planting date of July 21st and the harvest date of November 2nd. Cultivation 2 having the second earliest planting date, has the planting date of July 27th and the harvest date of November 16th. Cultivation 3 having the last planting date, has the planting date of July 31st and the harvest date of December 2nd. Namely, in cultivation schedule A, the harvest date of cultivation 2 comes 14 days after the harvest date of cultivation 1, and then, the harvest date of cultivation 3 comes 16 days after. Note that, in cultivation schedule A, a harvest date is a day when the harvest is planned or scheduled. In the following, a harvest date in cultivation schedule A is referred to as a “planned harvest date”. Note that planned harvest dates are designated by black circles in FIG. 1.

In cultivation schedule A, a planned harvest date corresponding to a planting date is calculated by using, for example, an effective accumulated temperature. It is assumed for the cabbage J that a day having the effective accumulated temperature greater than or equal to 1850° C.·day is determined as the planned harvest date. The effective accumulated temperature is an accumulated value of temperatures of the days that contribute growth. For example, for the cabbage J, if the average temperature of a day is over 5° C., the degrees over 5° C. are counted for the growth. If the average temperature of a day is 12° C., 12−5=7° C. is added to the effective accumulated temperature as contribution to the growth. An average temperature less than or equal to 5° C. is not added to the effective accumulated temperature. Assuming that the effective accumulated temperature of the cabbage J is 1850° C.·day, the planned harvest date of the cabbage J is a day having the effective accumulated temperature greater than or equal to 1850° C.·day since the planting date. Note that ° C.·day is a unit of the effective accumulated temperature in terms of the average temperature within a day.

When planning cultivation schedule A, the average temperatures of days until the planned harvest date are unknown. Therefore, for example, normal yearly values of the average temperatures of days in a region where cultivation of the cabbage J is carried out are used for days until the planned harvest date. Based on the normal yearly values, for example, a relationship between planting dates and planned harvest dates is obtained as illustrated in FIG. 2.

FIG. 2 is a schematic view illustrating an example of a relationship between planting dates and planned harvest dates of the cabbage J. In FIG. 2, the horizontal axis represents planting dates, and the vertical axis represents planned harvest dates. Cultivation schedule A illustrated in FIG. 1 is planned using information as illustrated in FIG. 2.

Note that a “harvest interval” refers to an interval between harvest dates in cultivations adjacent to each other in the following.

Even if cultivation is started following cultivation schedule A, a harvest date may not necessarily come as scheduled due to an influence of weather conditions and the like. Thereupon, a determination method will be described that determines a recommended day of harvest to make the shift smaller, taking a concrete case as an example where a shift from cultivation schedule A is anticipated. In the following, a recommended day of harvest is referred to as a “recommended harvest date” below.

Note that “cultivation” is a unit of work including various labors commonly carried out for the same breed of crops that is started with preparation of the cultivation and completed with the harvest of the crops in the present embodiment. Recommended harvest dates are determined with units of cultivations in the present embodiment.

FIG. 3 is a schematic view illustrating an example of a first case where shifts occur on forecasted harvest dates and harvest intervals in a cultivation schedule.

A case B illustrated in FIG. 3 is a case where forecasted harvest dates are anticipated to come behind cultivation schedule A based on a forecast of harvest dates made at a discretionary timing. Note that planting of cultivations has been carried out following cultivation schedule A in case B.

FIG. 3 illustrates an example where the discretionary timing is taken on October 10th. In this case, forecasted harvest dates of the cultivations are calculated as follows. First, using result values of average temperatures for days from the planting date to October 9th, an effective accumulated temperature is calculated. For days after October 10^{th}, the effective accumulated temperature is further accumulated using normal yearly values of average temperatures. A day having the effective accumulated temperature greater than or equal to 1850° C.·day is set as a forecasted harvest date. The forecasted harvest dates are represented by white circles in the present embodiment.

FIG. 3 illustrates the example where the forecasted harvest date of cultivation 1 is calculated as November 7th, the forecasted harvest date of cultivation 2 is calculated as November 24th, and the forecasted harvest date of cultivation 3 is calculated as December 16th, which are calculated on October 10th. Therefore, it is forecasted that a harvest interval between cultivation 1 and cultivation 2 is 17 days, and a harvest interval between cultivation 2 and cultivation 3 is 22 days. Namely, it is forecasted in case B that the forecasted harvest dates come behind the planned harvest dates of the cultivations, and the intervals between the forecasted harvest dates are longer than the intervals between the planned harvest dates of the cultivations. For example, when days having temperatures lower than the average temperatures continue, growth of the cabbage J is slower than in normal years, and a circumstance such as case B occurs.

FIG. 4 is a schematic view illustrating an example of a second case where shifts occur on forecasted harvest dates and harvest intervals in a cultivation schedule.

Case C illustrated in FIG. 4 is a case where forecasted harvest dates are anticipated to come ahead of cultivation schedule A base on a forecast of harvest dates made at a discretionary timing. Note that planting of cultivations has been carried out following cultivation schedule A in case C.

FIG. 4 also illustrates an example where the discretionary timing is taken on October 10th. In this case, forecasted harvest dates of the cultivations are calculated as described with FIG. 3.

FIG. 4 illustrates the example where the forecasted harvest date of cultivation 1 is calculated as October 24th, the forecasted harvest date of cultivation 2 is calculated as November 6th, and the forecasted harvest date of cultivation 3 is calculated as November 17th, which are calculated on October 10th. Therefore, it is forecasted that a harvest interval between cultivation 1 and cultivation 2 is 13 days, and a harvest interval between cultivation 2 and cultivation 3 is 11 days. Namely, it is forecasted in case C that the forecasted harvest dates come ahead of the planned harvest dates of the cultivations, and the intervals between the forecasted harvest dates are shorter than the intervals between the planned harvest dates of the cultivations. For example, when days having temperatures higher than the average temperatures continue, growth of the cabbage J is faster than normal years, and a circumstance such as case C occurs.

Recommended harvest dates are determined as follows for the cultivations in the above cases B and C according to the present embodiment. In the present embodiment, days are set as recommended harvest dates for the cultivations that makes harvest intervals of the cultivations close to those in cultivation schedule A.

When determining recommended harvest dates of the cultivations, a grace period is used that is defined for a harvest date of crops. Namely, for the cabbage J, the harvest may not necessarily be carried out on the very day when the effective accumulated temperature becomes 1850° C.·day. In general, an effective accumulated temperature has upper and lower margins. In the present embodiment, 1850° C.·day is allowed with margins of ±20° C.·day. Namely, for the cabbage J, the grace period of a harvest date starts on a day when the effective accumulated temperature reaches 1830° C.·day, and ends on a day the effective accumulated temperature goes over 1870° C.·day. Note that the grace period may be determined based on +N ° C.·day for crops that are suited to being set with only an upper margin of the effective accumulated temperature, instead of based on upper and lower margins of the effective accumulated temperature. If it is appropriate for the cabbage J to be set with a margin of +40° C.·day, the grace period of a harvest date may start on a day when the effective accumulated temperature reaches 1850° C.·day, and end on a day the effective accumulated temperature goes over 1890° C.·day.

Also, in the present embodiment, different determination methods are used for determining recommended harvest dates, depending on forecasted harvest dates that come behind or come ahead of cultivation schedule A for cultivations 1-3 as a whole. Whether the forecasted harvest dates come behind or come ahead of cultivation schedule A for cultivations 1-3 as a whole is determined by a result that summarizes individual relationships between the forecasted harvest dates and the planned harvest dates.

Specifically, for the forecasted harvest date of each of the cultivations, (forecasted harvest date−planned harvest date) is calculated. If the total of the calculation result is greater than or equal to 0, it is determined as being behind cultivation schedule A. If the total of the calculation result is less than 0, it is determined as being ahead of cultivation schedule A. The total of the calculation results here is the result that summarizes individual behind-ahead relationships. In the present embodiment, if the total is 0, the behind-ahead relationship is determined as behind, although it may be determined as ahead.

For example, for cultivations in case B, calculation results of (forecasted harvest date−planned harvest date) are as follows.

Cultivation 1: November 7th−November 2nd=5 days

Cultivation 2: November 24th−November 16th=8 days

Cultivation 3: December 16th−December 2nd=14 days

The total (5+8+14) is greater than or equal to 0; hence, it is determined that the forecasted harvest dates for cultivations 1-3 in case B are behind cultivation schedule A, namely, the result that summarizes the individual behind-ahead relationships between the forecasted harvest dates and the planned harvest dates is determined as behind.

On the other hand, for the cultivations in case C, calculation results of (forecasted harvest date−planned harvest date) are as follows.

Cultivation 1: October 24th−November 2nd=−9 days

Cultivation 2: November 6th−November 16th=−10 days

Cultivation 3: November 17−December 2nd=−15 days

The total (−9−10−15) is less than 0; hence, it is determined that the forecasted harvest dates for cultivations 1-3 in case C are ahead of cultivation schedule A, namely, the result that summarizes the individual behind-ahead relationships between the forecasted harvest dates and the planned harvest dates is determined as ahead.

As above, the determination method for the recommended harvest date in case B differs from the determination method for the recommended harvest date in case C in the present embodiment.

Thereupon, a determination method for recommended harvest dates will be described for a case where forecasted harvest dates of cultivations come behind a cultivation schedule as a whole, using case B. Note that when simply referring to a “grace period”, it means a grace period for a harvest date in the following.

FIG. 5 is a schematic view illustrating an example of a determination method of recommended harvest dates for a case where forecasted harvest dates of cultivations are behind a cultivation schedule as a whole. Namely, FIG. 5 illustrates a determination method for recommended harvest dates for the cultivations in case B. Note that grace periods of the cultivations are designated with parentheses following the forecasted harvest dates of the cultivations in FIG. 5. Also, thick lines behind and ahead of the forecasted harvest dates of the cultivations schematically represent the grace periods.

Recommended harvest dates are determined for the cultivations in case B, by the following steps (1)-(3).

(1) For cultivation 3, if the planned harvest date is within the grace period, the planned harvest date is set as the recommended harvest date. If the planned harvest date is out of the grace period, a day closest to the planned harvest date within the grace period is set as the recommended harvest date. Namely, for cultivation 3, a day included in the grace period is set as the recommended harvest date that has a minimum interval or difference with the planned harvest date.

Specifically, the planned harvest date of cultivation 3 is December 2nd as illustrated in FIG. 1. The planned harvest date is not included in a period from December 8th to January 19th, which is the grace period of cultivation 3 illustrated in FIG. 5. Therefore, December 8th is set as the recommended harvest date of cultivation 3, which is the closest day to December 2nd within the period from December 8th to January 19th. Note that the recommended harvest dates are designated with triangles in FIG. 5.

(2) For cultivation 2, if a day that is dated back from the recommended harvest date of cultivation 3 for the number of days of the interval between harvests of cultivation 3 and cultivation 2 in cultivation schedule A is included in the grace period of cultivation 2, the day is set as the recommended harvest date. If the day that is dated back from the recommended harvest date of cultivation 3 for the number of days of the interval between the harvests of cultivation 3 and cultivation 2 in cultivation schedule A is not included in the grace period of cultivation 2, a day closest to the day within the grace period is set as the recommended harvest date. Namely, for cultivation 2, a day included in the grace period of cultivation 2 is set as the recommended harvest date that has an interval to the recommended harvest date of cultivation 3 where the interval is closest to the interval between the planned harvest date of cultivation 3 and the planned harvest date of cultivation 2.

Specifically, the harvest interval between cultivation 3 and cultivation 2 is 16 days as illustrated in FIG. 1. November 22nd, which is 16 days before December 8th or the recommended harvest date of cultivation 3, is included in the grace period of cultivation 2 from November 21st to November 28th. Therefore, November 22nd is set as the recommended harvest date of cultivation 2.

(3) For cultivation 1, the recommended harvest date is determined in substantially the same way as in (2) where the relationship between cultivation 2 and cultivation 3 is replaced with the relationship between cultivation 1 and cultivation 2. Consequently, the recommended harvest date of cultivation 1 is set as November 8th.

Thus, the interval between the recommended harvest dates of cultivation 1 and cultivation 2 is 14 days. Also, the interval between the recommended harvest dates of cultivation 2 and cultivation 3 is 16 days. In this way, harvest intervals of the cultivations can be prevented from being deviated from cultivation schedule A.

Next, a determination method for recommended harvest dates will be described for a case where forecasted harvest dates of cultivations come ahead of a cultivation schedule as a whole, using case C.

FIG. 6 is a schematic view illustrating an example of a determination method of recommended harvest dates for a case where forecasted harvest dates of cultivations are ahead of a cultivation schedule as a whole. Namely, FIG. 6 illustrates a determination method for recommended harvest dates for the cultivations in case C. Notations in FIG. 6 are the same as in FIG. 5.

Recommended harvest dates are determined for the cultivations in case C, by the following steps (1)-(3). Recommended harvest dates are basically determined by prioritizing earlier forecasted harvest dates in case C, which differ from case B where recommended harvest dates are determined by prioritizing later forecasted harvest dates.

(1) For cultivation 1, if the planned harvest date is within the grace period, the planned harvest date is set as the recommended harvest date. If the planned harvest date is out of the grace period, a day closest to the planned harvest date within the grace period is set as the recommended harvest date. Namely, for cultivation 1, a day included in the grace period is set as the recommended harvest date that has a minimum interval or difference with the planned harvest date.

Specifically, the planned harvest date for cultivation 1 is November 2nd as illustrated in FIG. 1. The planned harvest date is not included in a period from October 22nd to October 25th, which is the grace period of cultivation 1 illustrated in FIG. 6. Therefore, October 25th is set as the recommended harvest date for cultivation 1, which is the closest day to November 2nd within the period from October 22nd to October 25th.

(2) For cultivation 2, if a day that is dated forward from the recommended harvest date of cultivation 1 for the number of days of the interval between harvests of cultivation 1 and cultivation 2 in cultivation schedule A is included in the grace period of cultivation 2, the day is set as the recommended harvest date. If the day that is dated forward from the recommended harvest date of cultivation 1 for the number of days of the interval between the harvests of cultivation 1 and cultivation 2 in cultivation schedule A is not included in the grace period of cultivation 2, a day closest to the day within the grace period is set as the recommended harvest date. Namely, for cultivation 2, a day included in the grace period of cultivation 2 is set as the recommended harvest date that has an interval to the recommended harvest date of cultivation 1 where the interval is closest to the interval between the planned harvest date of cultivation 1 and the planned harvest date of cultivation 2.

Specifically, the harvest interval between cultivation 1 and cultivation 2 is 14 days as illustrated in FIG. 1. November 8th, which is 14 days after October 25th or the recommended harvest date of cultivation 1, is included in the grace period of cultivation 2 from November 4th to November 8th. Therefore, November 8th is set as the recommended harvest date of cultivation 2.

(3) For cultivation 3, the recommended harvest date is determined in substantially the same way as in (2) where the relationship between cultivation 1 and cultivation 2 is replaced with the relationship between cultivation 2 and cultivation 3. Consequently, the recommended harvest date of cultivation 3 is set as November 20th.

Thus, the interval between the recommended harvest dates of cultivation 1 and cultivation 2 recommended harvest date is 14 days. Also, the interval between the recommended harvest dates of cultivation 2 and cultivation 3 is 12 days. In this way, harvest intervals of the cultivations can be prevented from being deviated from cultivation schedule A.

Incidentally, cultivation schedule A in the present embodiment is a cultivation schedule for cultivations that are carried out from summer to winter. Therefore, average temperatures of days are in a downward direction, which increases the number of days that are required to obtain a specific effective accumulated temperature, especially for later cultivations. Namely, in cultivation schedule A, harvest times come in a period where the rate of upward change of the effective accumulated temperature decreases day by day.

FIG. 7 is a schematic view illustrating an example of change of effective accumulated temperatures in seasons where average temperatures are in a downward direction. In FIG. 7, a dashed curve represents change of the effective accumulated temperature of cultivation 1, and a solid curve represents change of the effective accumulated temperature of cultivation 3.

For example, assuming that Δt in FIG. 7 represents a margin of the effective accumulated temperature for a harvest time of the cabbage J, the grace period T1 of cultivation 1 and the grace period T3 of cultivation 3 have a relationship of T1<T3.

Under such circumstances, if forecasted harvest dates come behind cultivation schedule A for all cultivations as in case B, harvest intervals of the cultivations can be made closer to cultivation schedule A, by harvesting ahead of the schedule as early as possible with prioritizing cultivation 3 that has the latest forecasted harvest date.

On the other hand, if forecasted harvest dates come ahead of cultivation schedule A for all cultivations as in case C, the grace periods of cultivations 1-3 are shorter than those in case B, respectively. Therefore, by making the recommended harvest date of cultivation 1, which has the shortest grace period, come closer to the planned harvest date as much as possible, and by determining the recommended harvest dates of the cultivations 2-3 using the recommended harvest date of cultivation 1 as a reference, the likelihood becomes higher in that obtained recommended harvest dates are closer to the harvest intervals in cultivation schedule A. This is because grace periods get longer for cultivation 2, and more for cultivation 3, which makes adjustable ranges greater.

Following the notion described above, recommended harvest dates are determined in FIG. 5 starting from cultivation 3, and recommended harvest dates are determined in FIG. 6 starting from cultivation 1.

On the other hand, for example, average temperatures of days are in an upward direction for a cultivation schedule where cultivations are carried out from winter to spring. Namely, with the cultivations carried out from winter to spring, harvest times come in a period where the rate of upward change of the effective accumulated temperature increases day by day. Therefore, the number of days required to obtain a specific effective accumulated temperature decreases especially for later cultivations. Therefore, for such a cultivation schedule having the harvest times in such a period, recommended harvest dates are determined based on logic that is inverse to the logic described with FIGS. 5-6. Namely, if forecasted harvest dates come behind the cultivation schedule, recommended days of cultivation are determined starting from a cultivation that has the earliest planned harvest date. If forecasted harvest dates come ahead of the cultivation schedule, recommended days of cultivation are determined starting from a cultivation that has the latest planned harvest date.

In practice, however, there may be cases where the order of determination, namely whether to start from a cultivation that has the earliest planned harvest date or the latest planned harvest date, depends on individual concrete circumstances, to obtain harvest intervals closer to the cultivation schedule.

Therefore, for both cases B and C, recommended days of cultivations may be determined in the two ways, namely using the method described with FIG. 5 and the method described with FIG. 6, and two determination results are compared with the cultivation schedule to select one of them to be adopted. Specifically, one determination result may be adopted among the two determination results that has a smaller shift from the cultivation schedule. The shift from a cultivation schedule may be evaluated with a total of shifts between the recommended harvest dates and the planned harvest dates for respective cultivations, or with a total of shifts of harvest intervals from the cultivation schedule. In this way, the likelihood can be raised in that recommended harvest dates are determined so that they are closer to harvest intervals in the cultivation schedule for individual concrete cases.

Next, a computer will be described that executes the determination methods for recommended harvest dates described above.

FIG. 8 is a schematic view illustrating an example of a hardware configuration of a harvest support apparatus according to the present embodiment. The harvest support apparatus 10 in FIG. 8 includes a drive unit 100, an auxiliary storage unit 102, a memory unit 103, a CPU 104, and an interface unit 105, which are mutually connected by a bus B.

A program that performs processing on the harvest support apparatus 10 is provided with a recording medium 101. When the recording medium 101 storing the program is set in the drive unit 100, the program is installed into the auxiliary storage unit 102 from the recording medium 101 via the drive unit 100. However, installation of the program is not necessarily executed from the recording medium 101, but may be downloaded from another computer via a network. The auxiliary storage unit 102 stores the installed program, and stores required files, data, and the like as well.

The memory unit 103 reads the program from the auxiliary storage unit 102 to store the program into it when receiving a start command for the program. The CPU 104 implements functions relevant to the harvest support apparatus 10 by executing the program stored in the memory unit 103. The interface unit 105 is used as an interface for connecting with a network.

Note that an example of the recording medium 101 may be a CD-ROM, a DVD disk, or a portable recording medium such as a USB memory. Also, an example of the auxiliary storage unit 102 may be an HDD (Hard Disk Drive), a flash memory, or the like. Both the recording medium 101 and the auxiliary storage unit 102 correspond to computer-readable recording media.

FIG. 9 is a schematic view illustrating an example of a functional configuration of the harvest support apparatus 10 according to the present embodiment. In FIG. 9, the harvest support apparatus 10 utilizes a cultivation schedule storage unit 11, a temperature history storage unit 12, a normal yearly temperature storage unit 13, and the like. These storage units may be implemented by the auxiliary storage unit 102 or a storage device connected with the harvest support apparatus 10 via a network.

The cultivation schedule storage unit 11 stores information that represents a cultivation schedule. The information that represents a cultivation schedule is referred to as the “cultivation schedule information” in the following. The cultivation schedule information includes, for example, a planting date and a planned harvest date for each cultivation.

The temperature history storage unit 12 stores a history of temperatures. A history of temperatures includes, for example, a history of result values of average temperatures of days in a predetermined period in the past. The history of temperatures stored in the temperature history storage unit 12 is updated, for example, every day. Namely, a result value of an average temperature for a day that has newly passed is stored in the temperature history storage unit 12. The normal yearly temperature storage unit 13 stores normal yearly temperature information. The normal yearly temperature information includes, for example, normal yearly values of average temperatures of days during a year.

The harvest support apparatus 10 also includes a forecast date calculation unit 14 and a recommended date determination unit 15. These units are implemented by procedures that a program installed in the harvest support apparatus 10 has the CPU 104 execute.

The forecast date calculation unit 14 calculates a forecasted harvest date and a grace period for each cultivation based on the cultivation schedule information, the history of temperatures, the normal yearly temperature information and the like.

The recommended date determination unit 15 determines a recommended harvest date for each cultivation based on the calculation result by the forecast date calculation unit 14.

In the following, a process will be described that is executed by the harvest support apparatus 10. FIG. 10 is a flowchart illustrating an example of a determination process of recommended harvest dates. The process in FIG. 10 is executed for cultivations whose cultivation schedule information is stored in the cultivation schedule storage unit 11 at an arbitrary timing after the start of cultivations such as planting or seeding.

At Step S101, the forecast date calculation unit 14 calculates a forecasted harvest date and a grace period for each of cultivations 1 to N relating to the cultivation schedule information stored in the cultivation schedule storage unit 11 (Step S101). The calculation result is stored in the memory unit 103 or the auxiliary storage unit 102. Note that the cultivations 1 to N are ordered where cultivation 1 comes first and the others follow in ascending order of planting dates and planned harvest dates. Therefore, the cultivation N is a cultivation that has the last planting date and planned harvest date.

The calculation method of forecasted harvest dates is as described in FIG. 3 and the like. Also, the calculation method of grace periods is as described in FIG. 5 and the like. In the case of FIG. 5 or FIG. 6, October 10th is the date of a day when the process in FIG. 10 is executed.

When calculating forecasted harvest dates, the effective accumulated temperature up to the day is calculated based on the history of temperatures stored in the temperature history storage unit 12. The effective accumulated temperature of the following days is calculated based on the normal yearly temperature information stored in the normal yearly temperature storage unit 13.

Note that Step S101 may be executed separately. For example, a result calculated on another computer for another purpose may be obtained at Step S101. In this case, the calculation result by the other computer may be stored in the auxiliary storage unit 102 beforehand, or may be input by a user at Step S101 to be stored in the memory unit 103 or the auxiliary storage unit 102.

Next, the recommended date determination unit 15 determines whether planned harvest dates of N cultivations are concentrated in a period from September 1st to the last day of February, by calculating a ratio of cultivations whose planned harvest dates are included in the period is greater than or equal to a predetermined value (Step S102).

The predetermined value is an arbitrary value over 50%. Namely, Step S102 determines whether a majority of the N cultivations have their planned harvest dates from fall to winter.

Cultivation schedule A in FIG. 1 has planned harvest dates of all cultivations in the period from September 1st to the last day of February. Therefore, the determination at Step S102 results in YES.

Note that cultivations may be divided into a group of cultivations whose planned harvest dates are set in fall to winter, and another group of cultivations whose planned harvest dates are set in spring to summer, to execute Steps S103 and after for the former group and to execute Steps S123 and after are for the latter group. Also, although seasons are separated on September 1st and the last day of February in the present embodiment, these dates for seasonal separation may be appropriately changed.

Note that the gist of Step S102 is to determine whether planned harvest dates of the cultivations are included in a period when the rate of upward change of the effective accumulated temperature decreases day by day, or in a period when the rate increases day by day. Therefore, instead of determining whether the planned harvest dates are included in the period from September 1st to the last day of February, it may be determined whether the normal yearly values of average temperatures of the planned harvest dates of the cultivations tend to increase, or tend to decrease. The normal yearly values of average temperatures of the planned harvest dates of the cultivations can be identified by referring to the normal yearly temperature storage unit 13.

Among the N cultivations, if the ratio of cultivations whose planned harvest dates are included in the period from September 1st to the last day of February is greater than or equal to the predetermined value (YES at Step S102), the recommended date determination unit 15 determines whether a total of (forecasted harvest date−planned harvest date) for the N cultivations is greater than or equal to 0 (Step S103). Namely, it is determined whether forecasted harvest dates of the cultivations come behind cultivation schedule As a whole.

If the total is less than 0, namely, if forecasted harvest dates of the cultivations come ahead of cultivation schedule As a whole (NO at Step S103), Steps S124 and after are executed as will be described later. If the total is greater than or equal to 0, namely, if forecasted harvest dates of the cultivations come behind cultivation schedule As a whole (YES at Step S103), the recommended date determination unit 15 determines whether the planned harvest date of the N-th cultivation is within the grace period of the cultivation (Step S104). Note that recommended harvest dates are determined for the cultivations by the process described in FIG. 5 at Steps S104 to S112. Namely, recommended harvest dates are determined in order starting from a cultivation that has the latest planting date and planned harvest date.

If the planned harvest date is within the grace period (YES at Step S104), the recommended date determination unit 15 determines the planned harvest date of the N-th cultivation as the recommended harvest date of the N-th cultivation (Step S105). On the other hand, if the planned harvest date is out of the grace period (NO at Step S104), the recommended date determination unit 15 determines a date in the grace period of the N-th cultivation closest to the planned harvest date as the recommended harvest date of the N-th cultivation (Step S106). Note that the recommended harvest date determined at Step S105 or S106 is stored in, for example, the memory unit 103 or auxiliary storage unit 102.

Next, the recommended date determination unit 15 sets (N−1) to a variable i (Step S107). The variable i is a variable used for following the order of cultivations to be processed. The i-th cultivation is referred to as “cultivation (i)” in the following.

Next, the recommended date determination unit 15 determines whether a day that is dated back from the recommended harvest date of cultivation (i+1) for the number of days of the interval between harvests of cultivation (i+1) and cultivation (i) is included in the grace period of cultivation (i) (Step S108). If the day is within the grace period (YES at Step S108), the recommended date determination unit 15 determines the day as the recommended harvest date of cultivation (i) (Step S109). On the other hand, if the day is out of the grace period (NO at Step S108), the recommended date determination unit 15 determines a date in the grace period closest to the planned harvest date as the recommended harvest date of cultivation (i) (Step S110). Note that the recommended harvest date determined at Step S109 or S110 is stored in, for example, the memory unit 103 or auxiliary storage unit 102.

Next, the recommended date determination unit 15 subtracts 1 from i (Step S111). If i is greater than or equal to 1, namely, if there are cultivations that do not have recommended harvest dates determined (NO at Step S112), Steps S108 and after are repeated. If i is less than 1, namely, if recommended harvest dates have been determined for all cultivations (YES at Step S112), the process in FIG. 10 ends.

On the other hand, among the N cultivations, if the ratio of cultivations whose planned harvest dates are included in the period from September 1st to the last day of February is less than the predetermined value (NO at Step S102), the recommended date determination unit 15 determines whether a total (forecasted harvest date−planned harvest date) for the N cultivations is greater than or equal to 0 (Step S123). Namely, it is determined whether forecasted harvest dates of the cultivations come behind cultivation schedule As a whole.

If the total is less than 0, namely, if forecasted harvest dates of the cultivations come ahead of cultivation schedule As a whole (NO at Step S123), Steps S104 and after are executed. If the total is greater than or equal to 0, namely, if forecasted harvest dates of the cultivations come behind cultivation schedule As a whole (YES at Step S123), the recommended date determination unit 15 determines whether the planned harvest date of the first cultivation is within the grace period of the cultivation (Step S124). Note that recommended harvest dates are determined for the cultivations by the process described in FIG. 6 at Steps S124 to S132. Namely, recommended harvest dates are determined in order starting from a cultivation that has the earliest planting date and planned harvest date.

If the planned harvest date is within the grace period (YES at Step S124), the recommended date determination unit 15 determines the planned harvest date of the first cultivation as the recommended harvest date of the first cultivation (Step S125). On the other hand, if the planned harvest date is out of the grace period (NO at Step S124), the recommended date determination unit 15 determines a date in the grace period closest to the planned harvest date as the recommended harvest date of the first cultivation (Step S126). Note that the recommended harvest date determined at Step S125 or S126 is stored in, for example, the memory unit 103 or auxiliary storage unit 102.

Next, the recommended date determination unit 15 sets 2 to the variable i (Step S127).

Next, the recommended date determination unit 15 determines whether a day that is dated forward from the recommended harvest date of cultivation (i−1) for the number of days of the interval between harvests of cultivation (i) and cultivation (i−1) is included in the grace period of cultivation (i) (Step S128). If the day is within the grace period (YES at Step S128), the recommended date determination unit 15 determines the day as the recommended harvest date of cultivation (i) (Step S129). On the other hand, if the day is out of the grace period (NO at Step S128), the recommended date determination unit 15 determines a date in the grace period closest to the planned harvest date as the recommended harvest date of cultivation (i) (Step S130). Note that the recommended harvest date determined at Step S129 or S130 is stored in, for example, the memory unit 103 or auxiliary storage unit 102.

Next, the recommended date determination unit 15 adds 1 to i (Step S111). If i is less than or equal to N, namely, if there are cultivations that have not recommended harvest dates determined (NO at Step S132), Steps S128 and after are repeated. If i is greater than N, namely, if recommended harvest dates have been determined for all cultivations (YES at Step S132), the process in FIG. 10 ends.

The recommended harvest dates of the cultivations stored in the memory unit 103 or auxiliary storage unit 102 are indicated by a predetermined method to a user, who may be a farmer. For example, the dates may be indicated by electronic mail, or they may be replied in response to a query made on a terminal used by the user. Also, if a display unit is connected with the harvest support apparatus 10, the dates may be displayed on the display unit.

Note that the process described in FIG. 10 may be executed periodically. By doing so, recommended harvest dates can be determined in a state where an influence of weather and the like after a previous execution of the process are reflected.

Also, regardless of the determination results at Steps S102, S103, and S123, or without executing these steps, Steps S104 and after or Steps S124 and after may be executed, followed by Steps S124 and after or Steps S104 and after, respectively.

In these cases, recommended harvest dates are determined for each cultivation (i) in two ways. The recommended date determination unit 15 calculates a total of absolute values of differences between recommended harvest dates and planned harvest dates where the recommended harvest dates have been determined at Steps S104 and after for the cultivations. The recommended date determination unit 15 also calculates a total of absolute values of differences between recommended harvest dates and planned harvest dates where the recommended harvest dates have been determined at Steps S124 and after for the cultivations. The recommended date determination unit 15 adopts recommended harvest dates that have a smaller calculated total of the differences.

Alternatively, the recommended date determination unit 15 calculates a total of absolute values of differences between intervals of the recommended harvest dates of the cultivations, which have been determined at Steps S104 and after, and harvest intervals in the cultivation schedule. The recommended date determination unit 15 also calculates a total of absolute values of differences between intervals of the recommended harvest dates of the cultivations, which have been determined at Steps S124 and after, and harvest intervals in the cultivation schedule. The recommended date determination unit 15 adopts recommended harvest dates that have a smaller calculated total of the differences.

Further, the two sets of recommended harvest dates may be proposed to the user. The user may select one set of recommended harvest dates, taking empirical knowledge of the user and other factors into consideration.

Note that although the examples in the present embodiment use the effective accumulated temperature for calculating forecasted harvest dates and grace periods, forecasted harvest dates may be calculated by other methods. Other parameters, for example, hours of sunshine and DVI (Development Index or growth index) values may be taken into consideration.

Also, instead of using information processing, forecasted harvest dates and grace periods may be forecasted for cultivations based on empirical knowledge of a farmer and calculation by a farmer. In this case, the forecasted harvest dates and grace periods for the cultivations may be input to the harvest support apparatus 10.

Also, although cultivation schedule A is taken as an example where crops of the same breed are planted on shifted dates in the present embodiment, breeds of crops of cultivations included in a cultivation schedule may be different from each other.

Also, cultivations included in a cultivation schedule may not be carried out in the same region. If cultivations are carried out in regions that are mutually different, the temperature history storage unit 12 and the normal yearly temperature storage unit 13 may be provided for each of the regions. The process in FIG. 10 may be executed using the temperature history storage unit and the normal yearly temperature storage unit 13 provided for each of the regions for the cultivations.

Also, the present embodiment may be applied to a cultivation schedule that requires planned harvest dates of the cultivations to coincide with each other.

As described above, the harvest support apparatus 10 in the present embodiment can propose recommended days of harvests by automatically calculating days with which shifts from cultivation schedule Are made smaller in terms of intervals of the harvest date of multiple cultivations. Consequently, a farmer can carry out harvests with regular intervals of harvest times of the cultivations.

Also, the adjustable range of a recommended harvest date is restricted within the grace period of a cultivation. Therefore, harvest dates can be recommended within respective periods suitable for a harvest with which shifts from a cultivation schedule can be made smaller.

Note that the recommended date determination unit 15 is an example of a determination unit in the present embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A harvest support method executed by a computer, the method comprising:
determining a day included in a harvest grace period of a first cultivation among a plurality of cultivations of crops as a recommended harvest date of the first cultivation, the day having a minimum interval with a planned harvest date of the first cultivation, the harvest grace period of the first cultivation and the planned harvest date of the first cultivation being stored in a storage unit; and
determining a day included in a harvest grace period of a second cultivation among the plurality of cultivations of crops as a recommended harvest date of the second cultivation, the day having an interval with the planned harvest date of the first cultivation in which the interval is closest to an interval between the planned harvest date of the first cultivation and a planned harvest date of the second cultivation, the harvest grace period of the second cultivation and the planned harvest date of the second cultivation being stored in the storage unit.

2. The harvest support method as claimed in claim 1, wherein the determining of the recommended harvest date of the first cultivation selects a cultivation having a latest planned harvest date among the plurality of cultivations of crops as the first cultivation to determine the recommended harvest date of the first cultivation.

3. The harvest support method as claimed in claim 1, wherein the determining of the recommended harvest date of the first cultivation selects a cultivation having an earliest planned harvest date among the plurality of cultivations of crops as the first cultivation to determine the recommended harvest date of the first cultivation.

4. The harvest support method as claimed in claim 1, wherein the determining of the recommended harvest date of the first cultivation further selects a cultivation having a latest planned harvest date among the plurality of cultivations of crops as the first cultivation to determine a first recommended harvest date of the first cultivation, and then selects a cultivation having an earliest planned harvest date among the plurality of cultivations of crops as the first cultivation to determine a second recommended harvest date of the first cultivation,
wherein the determining of the recommended harvest date of the second cultivation further determines the recommended harvest date for each of the first and second recommended harvest dates, and
wherein the determining of the recommended harvest date of the first cultivation further compares the first recommended harvest date and the recommended harvest date of the second cultivation for the first recommended harvest date, with the recommended harvest date of the first cultivation and the recommended harvest date of the second cultivation,
compares the second recommended harvest date and the recommended harvest date of the second cultivation for the second recommended harvest date, with the recommended harvest date of the first cultivation and the recommended harvest date of the second cultivation, and
depending on the comparison results, selects the first recommended harvest date or the second recommended harvest date as the recommended harvest date of the first cultivation.

5. A harvest support apparatus comprising:
a storage unit; and
a processor configured to determine a day included in a harvest grace period of a first cultivation among a plurality of cultivations of crops as a recommended harvest date of the first cultivation, the day having a minimum interval with a planned harvest date of the first cultivation, the harvest grace period of the first cultivation and the planned harvest date of the first cultivation being stored in the storage unit, and
to determine a day included in a harvest grace period of a second cultivation among the plurality of cultivations of crops as a recommended harvest date of the second cultivation, the day having an interval with the planned harvest date of the first cultivation where the interval is closest to an interval between the planned harvest date of the first cultivation and a planned harvest date of the second cultivation, the harvest grace period of the second cultivation and the planned harvest date of the second cultivation being stored in the storage unit.

6. A computer-readable recording medium having a program stored therein for causing a computer to execute a harvest support method, the method comprising:
determining a day included in a harvest grace period of a first cultivation among a plurality of cultivations of crops as a recommended harvest date of the first cultivation, the day having a minimum interval with a planned harvest date of the first cultivation, the harvest grace period of the first cultivation and the planned harvest date of the first cultivation being stored in a storage unit; and
determining a day included in a harvest grace period of a second cultivation among the plurality of cultivations of crops as a recommended harvest date of the second cultivation, the day having an interval with the planned harvest date of the first cultivation in which the interval is closest to an interval between the planned harvest date of the first cultivation and a planned harvest date of the second cultivation, the harvest grace period of the second cultivation and the planned harvest date of the second cultivation being stored in the storage unit.
